(19) United States
(12) Patent Application Publication
(10) Pub. No.: US 2013/0204705 A1
(43) Pub. Date: Aug. 8, 2013

(54) TARGETED LOCAL DEALS FOR CONTENT SHARING SITES BASED ON LOCATION METADATA

(71) Applicant: Jaewoo Song, Fremont, CA (US)

(72) Inventor: Jaewoo Song, Fremont, CA (US)

(73) Assignee: YAHOO! INC., Sunnyvale, CA (US)

(21) Appl. No.: 13/367,963

(22) Filed: Feb. 7, 2012

(51) Int. Cl. G06Q 30/02

(52) U.S. Cl. 705/14.58

(57) ABSTRACT

Techniques are provided for capturing and annotating content with location information, and for serving the annotated content with advertisements selected based on the location where the content was captured. A request to display content may be received. The content may have previously been captured by a handheld portable device that includes a location determiner. The handheld portable device automatically annotated the content with metadata that indicates a location of where the content was captured, as determined by the location determiner. In response to the received request, an advertisement selected based at least on the indicated location is requested, and the requested content is provided to be displayed with the advertisement.

### BACKGROUND OF THE INVENTION

1. Field of the Invention

The present invention relates to online display of content and selection of online advertisements.

2. Background Art

Websites exist that are accessible over the Internet (e.g., in the World Wide Web) and that enable content to be shared and displayed. For instance, photo sharing websites exist that enable users to publish their digital photos online for sharing with others (publicly or privately). Examples of such photo sharing websites include Webshots® created by Auralis, Inc., SmugMug provided by SmugMug, Inc., and Yahoo! Flickr™ provided by Yahoo! Inc. Social networking websites exist that enable the uploading and sharing of photos and other content, such as Facebook® operated by Facebook, Inc. of Palo Alto, Calif., and Google+ operated by Google, Inc. of Mountain View, Calif., etc. Some websites exist that enable the uploading and sharing of videos, including YouTube™ operated by Google, Inc.

Such websites may display advertisements alongside the displayed content. A large segment of such advertising is untargeted. Such untargeted advertising tends to be inefficient, and may be annoying to many computer users whose computer desktop may seem cluttered with undesired and uninteresting advertisements. In other cases, advertisements may be targeted to users by automated systems based on attributes of the users viewing the content. For example, a targeted advertisement selection system may select an advertisement to be displayed to a user based on user attributes such as the user's demographics, the user's interests, and/or the user's location.

### BRIEF SUMMARY OF THE INVENTION

Methods, systems, and apparatuses are provided for capturing and annotating content with location information. Furthermore, methods, systems, and apparatuses are provided for serving the annotated content with advertisements selected based on the location where the content was captured. In such manner, advertisements may be selected based on content capture location rather than merely being selected based on attributes of the recipient user.

In a method implementation, a request to display content may be received from a user device. The content may have previously been captured by a handheld portable device that includes a location determiner. The handheld portable device automatically annotated the content with metadata that indicates a location of where the content was captured, as determined by the location determiner. In response to the received request for content, an advertisement selected based at least on the indicated location is requested, and the requested content is provided to be displayed with the advertisement at the user device.

In a system implementation, an annotated content serving system is provided. The annotated content serving system includes a content request interface, an advertisement interface, and a content serving module. The content request interface receives a request to display content captured by a handheld portable. The handheld portable device automatically annotated the content with metadata indicating a location of where the content was captured, as was determined by a location determiner of the handheld portable device. The advertisement interface requests an advertisement selected based at least on the indicated location. The content serving module provides the content to be displayed with the requested advertisement.

Computer program products are also described herein. The computer program products include a computer-readable medium having computer program instructions recorded thereon that enable content and advertisements to be provided for display, where the content is annotated with a location where the content was captured, and the advertisements are selected based on the location where the content was captured.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a handheld portable device configured to capture and annotate content with location information, according to an example embodiment.

FIG. 2 shows a flowchart providing a process for capturing and annotating content with location information, according to an example embodiment.

FIG. 3 shows a block diagram of a content capture module that includes a camera for capturing images, according to an example embodiment.

FIG. 4 shows a block diagram of a content capture module that includes one or more of a video camera, a texting module, and an email tool, according to an example embodiment.

FIG. 5 shows a block diagram of a location determiner that includes a GPS (global positioning system) module, according to an example embodiment.

FIG. 6 shows a block diagram of a system for providing content and advertisements associated with a location where the content was captured, according to an example embodiment.

FIG. 7 shows a flowchart providing a process for responding to a request for content with the requested content and an advertisement associated with a location where the content was captured, according to an example embodiment.

FIG. 8 shows a block diagram of an annotated content serving system, according to an example embodiment.

FIG. 9 shows a block diagram of a first location in which content is captured and a second location where the content is viewed, according to an example embodiment.

FIG. 10 shows a block diagram of a computing device that displays a web page showing requested content and an advertisement associated with a location where the content was captured, according to an example embodiment.

FIG. 11 shows a block diagram of an example computer system in which embodiments may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection.

### II. Example Embodiments

Websites exist that are accessible over the Internet (e.g., in the World Wide Web) and that enable content to be shared and displayed. Such websites may display advertisements alongside the displayed content. Examples of online advertisement types include banner ads, floating ads, pop-up ads, and video ads which are provided through a browser to a user's computer desktop. Advertisements may be targeted to users by automated systems that select and serve advertisements based on attributes of the users viewing the content. For example, a targeted advertisement selection system may select advertisements based on user attributes such as the user's demographics, the user's interests, and/or the user's location and/or keywords included in the content. However, such advertisements are not typically selected based on a location where the content itself was captured.

Many handheld devices exist that are capable of capturing content, such as images, video, text messages, emails, etc. For instance, smart phones exist that have built in cameras for capturing images, and that also include GPS (global positioning system) functionality for determining a current location. Exchangeable image file format (EXIF) is a standard that specifies a file format for images, sound, and ancillary tags used by digital cameras (including smart phones) (e.g., for JPEG image files). Smart phones that can capture images and determine location may have the ability to store an indication of a location of where an image was captured as part of the file EXIF data.

According to embodiments, when content is uploaded to a content sharing site, location data associated with the content may be extracted from the content, and the location data may be used to select advertisements that are local to the location where the content was captured. For instance, in the case of an image, when an image is uploaded to a photo sharing site, location data indicating a location of where the image was captured may be extracted from the image file, and the location data may be used to select advertisements. As such, the advertisements may advertise for entities that are local to or associated with the location where the image was captured. The selected advertisements may be displayed with the content on a page. In the case of an image (e.g., a digital photo) of a location of interest, the image may engage users to want to visit that location to see the location for themselves. By presenting advertisements (e.g., local deals) related to the general vicinity of the captured image, users may be more engaged and more likely to avail themselves of deals in that general vicinity when they do visit the location.

Example embodiments are provided in the following subsections for capturing and annotating content with location information, and for providing content and advertisements associated with the location where the content was captured, as well as further embodiments.

A. Example Embodiments for Capturing and Annotating Content with Location Information

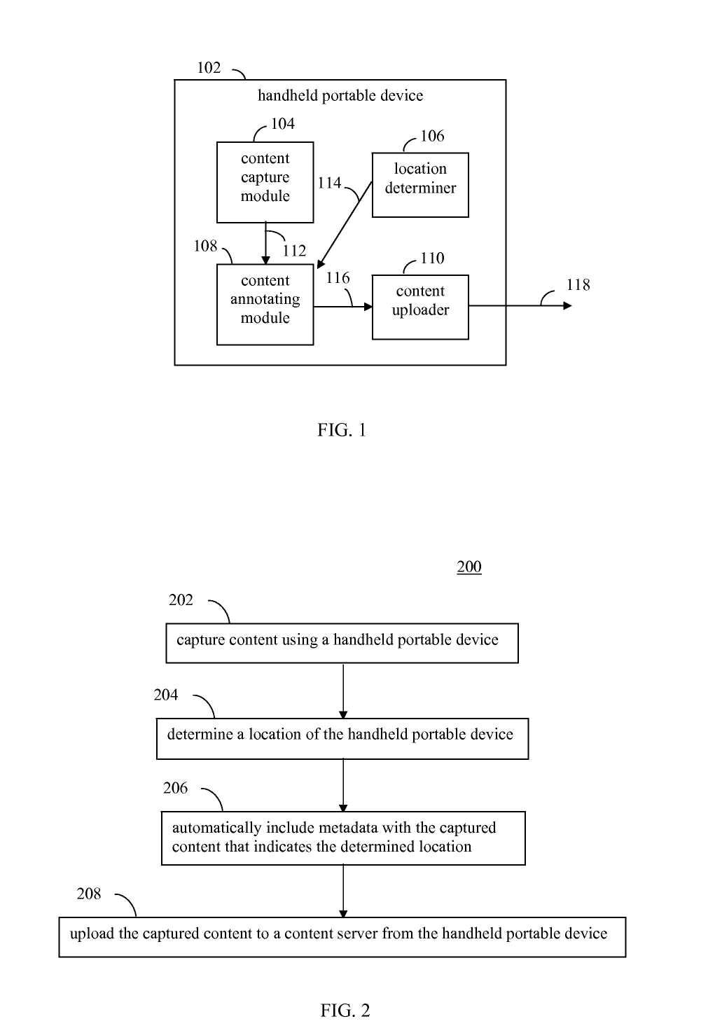

Embodiments relate to devices that are capable of capturing content, and that are capable of annotating the content with an indication of the location where the content was captured. Various types of portable devices may be capable of capturing and annotating various types of content, such as images, video, text messages, and emails. For instance, FIG. 1 shows a block diagram of a handheld portable device 102 configured to capture and annotate content with location information, according to an example embodiment. As shown in FIG. 1, handheld portable device 102 includes a content capture module 104, a location determiner 106, a content annotating module 108, and a content uploader 110. Handheld portable device 102 is described as follows.

Handheld portable device 102 may be any type of portable electronic device, such as digital handheld camera, a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), or a smart phone (e.g., an Apple iPhone, a Google Android™ phone, a Microsoft Windows® phone, etc.), or other type of mobile computing device.

In an embodiment, handheld portable device 102 of FIG. 1 may operate according FIG. 2. FIG. 2 shows a flowchart 200 providing a process for capturing and annotating content with location information, according to an example embodiment. For illustrative purposes, flowchart 200 is described as follows with respect to FIG. 1. Further structural and operational embodiments will be apparent to persons skilled in the relevant art(s) based on the following discussion regarding flowchart 200 and handheld portable device 102.

Flowchart 200 begins with step 202. In step 202, content is captured using a handheld portable device. For instance, in an embodiment, content capture module 104 may be configured to enable handheld portable device 102 to capture content. As shown in FIG. 1, content capture module 104 outputs captured content 112. Captured content 112 may include any type of captured content, including an image (e.g., an image file, such as a JPEG, GIF, or other type of image file), a video (e.g., a video file, such as an MPEG, a QTFF (QuickTime File Format), or other type of video file), a text message, an email, etc. Content may be captured by content capture module 104 in various ways, including by content capture module 104 including an automated mechanism for capturing content in response to a user command, by receiving content manually entered into content capture module 104 by a user, and/or in other ways.

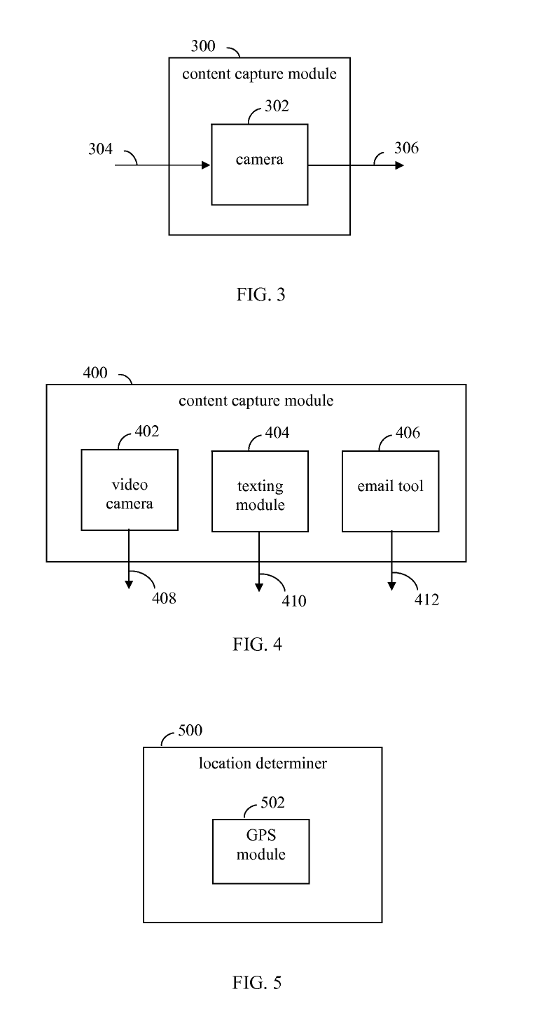

For instance, FIG. 3 shows a block diagram of a content capture module 300 that includes a camera for capturing images, according to an example embodiment. Content capture module 300 is an example of content capture module 104 of FIG. 1. As shown in FIG. 3, content capture module 300 includes a camera 302. Camera 302 is configured to capture images. For instance, as shown in FIG. 3, camera 302 receives light 304 corresponding to a scene in the physical world, and generates a digital image 306 corresponding to the scene. Camera 302 may be configured in various ways to capture images, in embodiments. For instance, camera 302 may include one or more lenses, and may include an image sensor. Such an image sensor may be configured in various ways, such as including an array of photoelectric light sensors, such as a charge coupled device (CCD) or a CMOS (complementary metal-oxide-semiconductor) sensor device. The image sensor receives light 304, which may optionally be filtered by one or more lenses, and generates one or more arrays of pixel values corresponding to an array of pixel sensors of the image sensor (e.g., a two-dimensional array of pixels). The pixel values may be stored in an image file output as digital image 306. In other embodiments, camera 302 may capture an image in other ways, as would be known to persons skilled in the relevant art(s).

In other embodiments, content capture module 104 may be configured to capture other forms of content. For instance, FIG. 4 shows a block diagram of a content capture module 400 that is configured to capture content, according to an example embodiment. Content capture module 400 is an example of content capture module 104 of FIG. 1. As such in FIG. 4, content capture module 400 includes a video camera 402, a texting module 404, and an email tool 406. In embodiments, content capture module 400 may include any one or more of video camera 402, texting module 404, and email tool 406.

Video camera 402 enables content capture module 400 to capture video. For instance, in embodiments, video camera 402 may include a camera similar to camera 302 of FIG. 3 that enables a stream of images to be captured and stored as a video file (e.g., an MPEG file, etc.). In other embodiments, video camera 402 may capture video in other ways, as would be known to persons skilled in the relevant art(s).

Texting module 404 enables content capture module 400 to capture text messages. For instance, texting module 404 may generate a user interface that is displayed by a display of handheld portable device 102 (FIG. 1). The user interface may enable a user to input a message by typing (e.g., using a physical or virtual keyboard) or by voice input (e.g., using voice recognition). The user may be enabled to speak or select “send,” or interact with the user interface in a different manner, to cause the device to transmit the text message to a content server, to be transmitted one or more target recipients. For instance, the message may be transmitted according to the Short Message Service (SMS), or may be transmitted according to the Multimedia Messaging Service (MMS) if the message includes multimedia content (e.g., images, etc.). In other embodiments, texting module 404 may capture text messages in other ways, as would be known to persons skilled in the relevant art(s).

Email tool 406 enables content capture module 400 to capture email messages. For instance, email tool 406 may generate a user interface that is displayed by a display of handheld portable device 102 (FIG. 1). The user interface may enable a user to input an email message by typing (e.g., using a physical or virtual keyboard) or by voice input (e.g., using voice recognition). The user may be enabled to speak or select “send,” or interact with the user interface in a different manner, to cause the device to transmit the email message to one or more target recipients. For instance, the message may be transmitted according to the Simple Mail Transfer Protocol (SMTP). In other embodiments, email tool 406 may capture emails messages in other ways, as would be known to persons skilled in the relevant art(s).

Note that the embodiments of content capture module 104 shown in FIGS. 3 and 4 are provided for purposes of limitation and are not intended to be limiting. In embodiments, further types of content may be captured using content capture module 104, as would be apparent to persons skilled in the relevant art(s) from the teachings herein.

Referring back to FIG. 2, in step 204, a location of the handheld portable device is determined. For instance, in an embodiment, location determiner 106 of FIG. 1 may be configured to enable handheld portable device 102 to determine a location of handheld portable device 104. As shown in FIG. 1, location determiner 106 outputs a determined location 114. Determined location 114 may be a data structure having any form, and may contain location information in any format, such as GPS coordinates, latitude, longitude, altitude, etc. For instance, location determiner 106 may be caused to determine a location of handheld portable device 102 by user command, whenever content capture module 104 captures content (e.g., location determiner 106 may receive a trigger signal from content capture module 104 when content is captured, or may receive the same trigger signal as is received by content capture module 104 from other entity). A location may be determined by location determiner 106 in various ways, including using GPS (global positioning system) techniques, local positioning systems (e.g., using cellular base stations, Wi-Fi access points, radio towers, etc.), and/or using other positioning techniques.

For instance, FIG. 5 shows a block diagram of a location determiner 500 configured to determine location using GPS techniques, according to an example embodiment. Location determiner 500 is an example of location determiner 106 of FIG. 1. As shown in FIG. 5, location determiner 500 includes a GPS module 502. GPS module 502 is configured to determine a location of a device. For instance, GPS module 502 may include one or more receivers that receive GPS signals from satellites for the purpose of determining a current location on Earth of the device. GPS module 502 may calculate its location by timing the signals transmitted by the GPS satellites. GPS module 502 may determine the transit time of each signal and may calculate the distance to each satellite. These distances, along with the locations of the satellites, may be used in a positioning algorithm (e.g., trilateration, etc.) to determine the location of GPS module 502. GPS module 502 may generate the location in the form of latitude and longitude, and in some embodiments may also determine altitude. In other embodiments, GPS module 502 may determine location in other ways, as would be known to persons skilled in the relevant art(s).

Note that the embodiment of location determiner 106 shown in FIG. 5 is provided for purposes of limitation and are not intended to be limiting. In embodiments, location may be determined in other ways using location determiner 106, as would be apparent to persons skilled in the relevant art(s) from the teachings herein.

Referring back to FIG. 2, in step 206, metadata is automatically included with the captured content that indicates the determined location. For instance, in an embodiment, content annotating module 108 of FIG. 1 may be configured to annotate the content captured by content capture module 104 with the location determined by location determiner 106. As shown in FIG. 1, content annotating module 108 may receive captured content 112 and determined location 114, and may generate annotated content 116, which is the content of captured content 112 annotated with the location of determined location 114. In an embodiment, content capture module 104 may generate the captured content in the form of a file (e.g., same type of file as received in captured content 112, or a different type of file). In such an embodiment, content annotating module 108 may annotate the file with metadata that indicates the determined location. For instance, content annotating module 108 may insert the determined location as metadata in the file in any location, including a header of the file, a body of the file, and/or in other location. The determined location may be indicated in the file as metadata in any manner, including as a data attribute, as a tag, or in other form. For instance, if the file is generated according to EXIF (e.g., a JPEG file, a TIFF file, etc.), the location may be included in the EXIF data stored in the file according to a standard or special purpose location information tag. In other embodiments, content may be annotated with location information as metadata in other ways, as would be apparent to persons skilled in the relevant art(s) from the teachings herein.

In step 208, the captured content is uploaded to a content server from the handheld portable device. For instance, in an embodiment, content uploader 110 of FIG. 1 may be configured to upload the content that was annotated by content capture module 104 with the location determined by location determiner 106. For example, as shown in FIG. 1, content uploader 110 receives annotated content 116, and transmits annotated content 116 as annotated content 118 to a content server of a content sharing site for uploading and storage.

In an embodiment, content uploader 110 may upload annotated content 118 to a content server automatically. In another embodiment, content uploader 110 may provide a user interface at handheld portable device 102 (FIG. 1) with which a user may interact to select annotated content 116 to be uploaded to a selected content server as annotated content 118. Content uploader 110 may transmit annotated content 118 to the content server according to any suitable communication protocol, including TCP/IP (Transmission Control Protocol/Internet Protocol), User Datagram Protocol (UDP), etc. Furthermore, content uploader 110 may transmit annotated content 118 to the content server according to any suitable file transfer protocol, including FTP (File Transfer Protocol), HTTP (Hypertext Transfer Protocol) (e.g., a “PUT” request method), etc.

### B. Example Embodiments for Providing Content and Advertisements Associated with the Content Capture Location

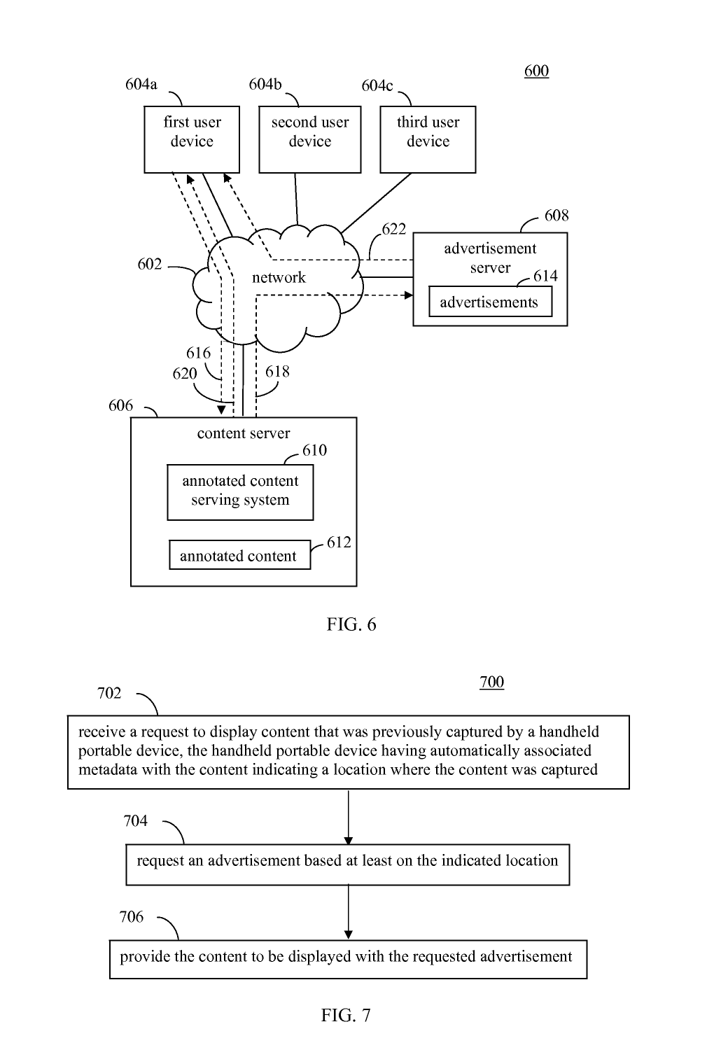

As described above, according to embodiments, users may request content, and the content may be provided to the users for display with advertisements selected based on metadata annotating the content (e.g., a location where the content was captured). Such embodiments may be implemented in various environments. For instance, FIG. 6 illustrates an example environment in which content and advertisements may be served. FIG. 6 shows a block diagram of a system for providing content and advertisements, according to an example embodiment. As shown in FIG. 6, system 600 includes first-third user devices 604a-604c, a content server 606, and an advertisement server 608. System 600 is described as follows as an example environment for embodiments, but is not intended to be limiting. Embodiments may be implemented in further types of environments.

First-third user devices 604a-604c, content server 606, and advertisement server 608 are connected to a communication network 602. Network 602 may be any type of communication network, such as a local area network (LAN), a wide area network (WAN), or a combination of communication networks, and may include one or more wireless and/or wired links. Network 602 may include one or more routers, hubs, switches, bridges, etc., used to connect devices/networks and/or to forward data (e.g., data packets). In embodiments, network 602 may include the Internet and/or an intranet. Network 602 may enable RF (radio frequency) or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. User devices 604a-604c, content server 606, and advertisement server 608 may communicate with each other over network 602.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

When signals are transmitted in signal packets in network 602, such signal packets may be compatible with or compliant with one or more protocols. Signaling formats or protocols employed may include, for example, TCP/IP, UDP, DECnet, NetBEUI, IPX, Appletalk, or the like. Example versions of the Internet Protocol (IP) may include IPv4 or IPv6.

User devices 604a-604c may each be any suitable type of electronic device, typically having a display and having web browsing capability (or other suitable network communication functionality), including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device. Although three user devices 604a-604c are shown in FIG. 6, any number of user devices 604 may be present in system 600 and coupled to network 602, including ones, tens, hundreds, thousands, millions, and even larger numbers of user devices 604.

In embodiments where network 602 includes the Internet, content (e.g., documents) is available for retrieval by user devices 604a-604c through network 602 from the World Wide Web. On the Internet, content may be identified/located by a uniform resource locator (URL), such as http://www.documents.com/documentX, and/or by other mechanisms. User devices 604a-604c can access content through network 602 by supplying a URL corresponding to the content to a content server, such as content server 606. Content server 606 maintains and serves content, including annotated content 612.

For example, content server 606 may include a device that includes a configuration to provide content via network 602 to another device. A content server may, for example, host a content sharing sites, such as a social networking website, examples of which may include, without limitation, Flickr®, Twitter®, Facebook®, Google+, LinkedIn®, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

As shown in FIG. 6, content server 606 includes an annotated content serving system 610 configured to serve annotated content 612. Annotated content 612 is content uploaded to content server that is annotated with location information indicating where the content was captured (e.g., as described in the above subsection). An example of annotated content 612 is annotated content 118 shown in FIG. 1. Furthermore, as shown in FIG. 6, advertisement server 608 includes advertisements 614, which may include any number of advertisements. Advertisement server 608 is configured to serve advertisements to be displayed with content. For instance, advertisement server 608 may receive requests for advertisements from user devices 604a-604c and/or content server 606. In embodiments, advertisement server 608 may select advertisements for display alongside annotated content based at least on the location information annotated to the content (and optionally on further information, including user attributes, etc.). Examples of advertisement servers 608 will be known to persons skilled in the relevant art(s).

Note that any number of content servers 606 and advertisement servers 608 may be present in system 600 and coupled to network 602, including ones, tens, hundreds, thousands, millions, and even larger numbers of such servers.

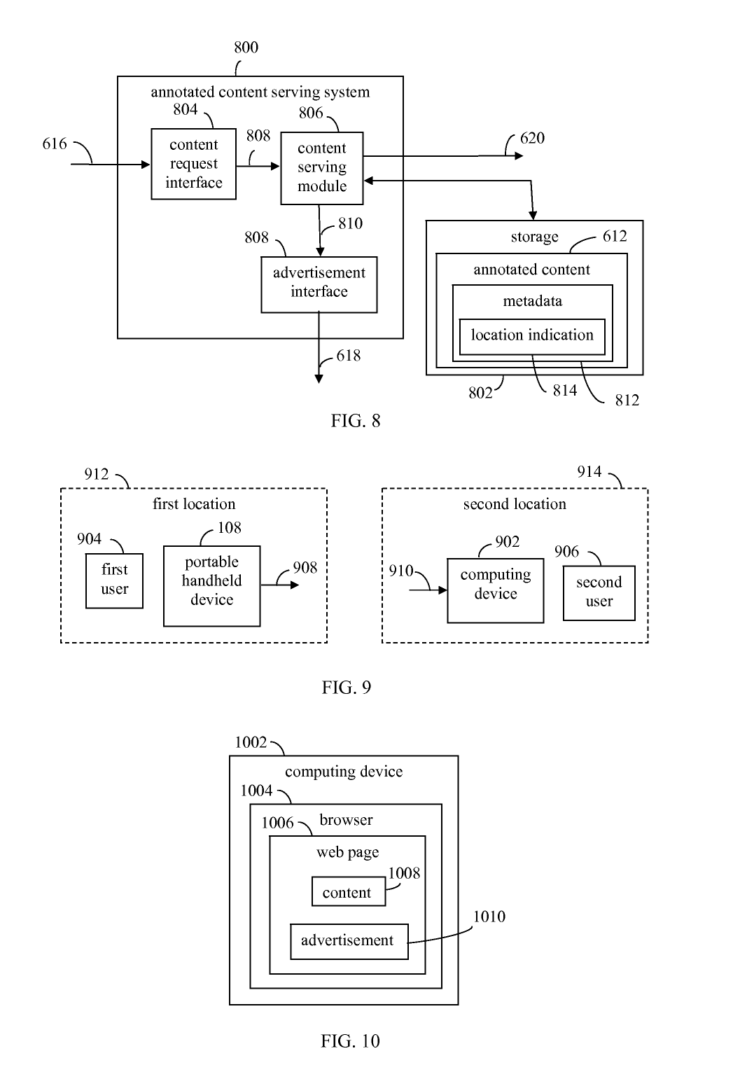

Annotated content serving system 610 may function in various ways to perform its functions. For instance, in an embodiment, annotated content serving system 610 of FIG. 6 may operate according FIG. 7. FIG. 7 shows a flowchart 700 providing a process for responding to a request for content with the requested content and an advertisement associated with a location where the content was captured, according to an example embodiment. For illustrative purposes, flowchart 700 is described as follows with respect to FIGS. 6 and 8. FIG. 8 shows a block diagram of an annotated content serving system 800, according to an example embodiment. Annotated content serving system 800 is an example of annotated content serving system 610 of FIG. 6. As shown in FIG. 8, annotated content serving system 800 includes a content request interface 804, a content serving module 806, and an advertisement interface 808. Further structural and operational embodiments will be apparent to persons skilled in the relevant art(s) based on the following discussion regarding flowchart 700 and annotated content serving system 800.

Flowchart 700 begins with step 702. In step 702, a request is received to display content that was previously captured by a handheld portable device, the handheld portable device having automatically associated metadata with the content indicating a location where the content was captured. For example, as shown in FIG. 6, content server 606 may receive a content request 616 from first user device 604a through network 602. Annotated content serving system 610 of content server 606 may process content request 616. For instance, annotated content serving system 610 may be a web server, a web service, or other system for serving content. Content request 616 is a request for content to be retrieved and transmitted to first user device 604a for display to a user of first user device 604a. Content request 616 may be a request for any type of content, such as an image, a video, email, etc. Such content may reside in a web page or other document, or in other form. Content request 616 may have any form to request content. For instance, content request 616 may be an HTTP request message (e.g., a “GET” request method) provided by a browser at user device 604a, a request to download email from a remote email inbox, or may be another type of request.

Referring to FIG. 8, content request interface 804 of annotated content serving system 800 receives and optionally filters content request 616. For instance, content request interface 804 may be a web server interface, a web service interface, an API (application programming interface), or other type of interface. As shown in FIG. 8, content request interface 804 outputs optionally filtered content request 808, which indicates the requested content.

Referring back to FIG. 7, in step 704, an advertisement is requested based at least on the indicated location. For example, as shown in FIG. 8, content serving module 806 may receive optionally filtered content request 808. Content serving module 806 may determine the requested content indicated in optionally filtered content request 808, such as by a file name, a URL, or other type of content identifier. Content serving module 806 may access storage 610 for the requested content. As shown in FIG. 8, storage 802 may store annotated content 612, which may be the requested content. Content serving module 806 may retrieve annotated content 612 from storage 802. Annotated content 612 may be any type of content, such as an image, a video, an email, etc.

Content serving module 806 may parse annotated content 612 for a location indication that indicates a location at which annotated content 612 was captured. For instance, as shown in FIG. 8, annotated content 612 may be a file that includes metadata 812. Metadata 812 is metadata associated with annotated content 612. As shown in FIG. 8, metadata 812 may include a location indication 814. Location indication 814 indicates a location at which annotated content 612 was captured. For instance, annotated content 612 may have been annotated with metadata 812 as described above in the prior subsection. Metadata 812 may be included in annotated content 612 in any location, including a file header, a file body, and/or in an alternative location. Location indication 814 may be indicated in metadata 812 in any manner, including as a data attribute, as a tag (e.g., an EXIF tag), or in other form. In an embodiment, content serving module 806 may output location indication 814 as determined location 810.

As shown in FIG. 8, advertisement interface 808 may receive determined location 810. Advertisement interface 808 may be configured to provide determined location 810 to an advertisement server to be used when selecting one or more advertisements to be displayed with annotated content 612. As shown in FIG. 8, advertisement interface 808 may transmit determined location 810 from annotated content serving system 800 in advertisement request 618. As shown in FIG. 6, advertisement request 618 is transmitted from content server 606 through network 602 to advertisement server 608. Note that advertisement request 618 may also identify first user device 604a (e.g., by IP address, etc.), and may identify the document (e.g., web page) in which a requested advertisement is to be displayed at first user device 604a. In response to advertisement request 618, advertisement server 608 may select one or more of advertisements 614 to be transmitted to first user device 604a to be displayed with the requested content. As shown in FIG. 6, advertisement server 608 may transmit an advertisement response 622 to first user device 604a that includes the one or more selected advertisements.

Advertisement server 608 may select the one or more advertisements based at least on the location indicated in advertisement request 618. For instance, advertisement server 608 may select one or more advertisements that have the indicated location as a location attribute or location metadata. In another example, advertisement server 608 may determine one or more advertising entities (e.g., advertisers, companies, merchants, stores, restaurants, etc.) that are located within a vicinity of the indicated location, and may select one or more of the advertisements of those advertising entities to be provided in advertisement response 622. In one example, a set of advertisements of advertising entities within a predetermined distance from the indicated location may be selected from by advertisement server 608. In another example, if the location is indicated by a location identifier, such as a city name, a county name, a state name, etc., a set of advertisements of advertising entities residing within the indicated location may be selected from by advertisement server 608. In still another example, with regard to travel-related businesses (e.g., airlines, train lines, bus lines, etc.), a set of advertisements of advertising entities providing travel to and/or from indicated location may be selected from by advertisement server 608.

For instance, in one example, advertisement server 608 may select an advertisement of an airline (or other travel-related entity) that advertises flights from a location of a user at user device 604a to the location at which the content was captured. This may encourage the user to travel to the location at which the content was captured. The location of user device 604a may be determined in various ways, such as by an IP address of user device 604a, by GPS positioning of user device 604a, by location information associated with a profile of the user of user device 604a, and/or by other technique. This location of user device 604a may be provided to the advertisement server by user device 604a and/or by the content server, may be stored at the advertisement server, or may be provided to the advertisement server in another manner to be used for advertisement selection. The selected advertisement may be provided for display at user device 604a with the content. The advertisement may identify the airline, provide flight rates/prices, provide dates during which special rates are available, and/or provide further information.

FIG. 9 illustrates an example of such a situation, showing a block diagram of a first location 912 in which content is captured and a second location 914 where the content is subsequently viewed, according to an example embodiment. As shown in FIG. 1, a first user 904 may use portable handheld device 108 to capture content (e.g., take a picture to capture an image) at a first location 912. The content may be annotated with the first location 912, as described in the prior subsection above. As shown in FIG. 9, portable handheld device 908 may upload the captured and annotated content to a content server as annotated content 908. Subsequently, a second user 906 may use a computing device 902 at second location 914 to download the annotated content from a content server for viewing as downloaded content 910. One or more advertisements may be selected and provided to be displayed with downloaded content 910 at computing device 902 as described above. Accordingly, in an embodiment, an advertisement may be selected that relates to the first location 912 (at which the content was captured) for display at computing device 902 at second location 914 (which is different from first location 912). For instance, the selected advertisement may advertise a business located in the vicinity of first location 912. In another example, the selected advertisement may advertise flights from a location of computing device 902 (e.g., a nearby city having an airport) to the location at which the content was captured by portable handheld device 108.

Note that in some situations, although not shown in FIG. 6, a browser of first user device 604a may transmit an advertisement request directly to advertisement server 608 for the one or more advertisements (rather than the advertisement request coming from content server 606). In such an embodiment, after receiving the request, and before providing the advertisement(s), advertisement server 608 may await (or may request) advertisement request 618 to be transmitted from content server 606 for the indication of the location of where the requested content was captured. In this manner, the location may be used to select the advertisement(s) to be transmitted to first user device 604a in advertisement response 622.

Note that storage 802 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Referring back to FIG. 7, in step 706, the content is provided to be displayed with the requested advertisement. For example, as shown in FIG. 8, content serving module 806 may transmit annotated content 612 to the requesting device as content response 620. As shown in FIG. 6, first user device 604a may receive content response 620 through network 602. Content response 620 may have any suitable form. For instance, content response 620 may be a server response to an HTTP request message, a response to a download email request, or may be another type of response.

The content received in content response 620 and the one or more advertisements received in advertisement response 622 may be displayed by a display screen of first user device 604a. For instance, FIG. 10 shows a block diagram of a computing device 1002 having a browser 1004 that displays a web page 1006 showing requested content 1008 and an advertisement 1010 associated with a location where content 1008 was captured, according to an example embodiment. Browser 1004 may be any type of browser, including Internet Explorer®, developed by Microsoft Corp. of Redmond, Wash., Mozilla Firefox®, developed by Mozilla Corp. of Mountain View, Calif., Safari®, developed by Apple Inc. of Cupertino, Calif., and Google® Chrome of Mountain View, Calif. Content 1008 may be any type of content, including an image, a video, a text message, an email, etc. Advertisement 1010 may be any type of advertisement, such as a banner ad, a floating ad, a pop-up ad, or a video ad. Advertisement 1010 may have any position in web page 1006 with respect to content 1008, including being shown above content 1008 (e.g., a North banner ad), to the right or left of content 1008, or being below content 1008.

Note that as described above, content that may be annotated with location information may include text messages or other types of content that is pushed to users, rather than being requested from content server 606. In such an embodiment, step 702 of flowchart 700 (FIG. 7) may not be performed. Instead, content server 606 may be a messaging server (or other content pushing server) that receives and forwards text messages to their target recipients. Thus, content server 606 may receive a text message annotated with a location at which the text message was captured (e.g., was input by a sending user). In such case, annotated content serving system 610 may perform step 704 (to request one or more advertisements based on the capture location) and step 706 (to provide the text message to the target recipient at the user's device). The target recipient may view the text message at their device alongside the one or more advertisements selected based on the capture location.

As such, embodiments enable content to be annotated with the location in which the content is captured, and for advertisements to be selected for display with the content based on the location. For instance, as described above, GPS positioning techniques may be used to determine a location that is annotated to an image (e.g., a JPEG file) or other content. In the case of an image, the image may be uploaded to a photo sharing site, and advertisements for localized deals (e.g., as exemplified by www.groupon.com of Groupon, Inc., and livingsocial.com of LivingSocial Inc.) may be displayed alongside the image to viewers. In this manner, advertisements may be displayed to viewers that may be drawn to deals that are local to where content was captured, such as locations where images are taken in popular tourist attractions. The location data may be extracted from EXIF data or other data from the uploaded content to be used to select advertisements. Local ads/deals may be displayed based on the capture location of the content, and such ads may be desired by viewers that want to visit the location of where the content was captured.

In contrast to conventional techniques, where local ads/deals are typically targeted to the advertisement viewer's location, viewers of content can be provided with deals that are local to where the content was captured. For example, if a picture (image) is taken in Union Square in San Francisco, and that picture is uploaded to a photo sharing site and/or social networking site, location data that is annotated to the file of the picture may be extracted from the file. Ads that are local to San Francisco, such as hotel deals or cheap flights to San Francisco, may be displayed that may be more likely to engage a viewer to want to visit that location. In another example, images may be captured at a popular tourist attraction. Deals that are local to the tourist attraction may be displayed to viewers of the images, such as deals for lodging, food, and/or entertainment that a viewer can purchase when they visit the tourist attraction.

### III. Example Computer Implementation

Content capture module 104, location determiner 106, content annotating module 108, content uploader 110, content capture module 300, camera 302, content capture module 400, video camera 402, texting module 404, email tool 406, location determiner 500, GPS module 502, annotated content serving system 610, annotated content serving system 800, content request interface 804, content serving module 806, advertisement interface 808, flowchart 200, flowchart 700, and/or any further systems, sub-systems, and/or components disclosed herein may be implemented in hardware, software, firmware, or any combination thereof. For example, content capture module 104, location determiner 106, content annotating module 108, content uploader 110, content capture module 300, camera 302, content capture module 400, video camera 402, texting module 404, email tool 406, location determiner 500, GPS module 502, annotated content serving system 610, annotated content serving system 800, content request interface 804, content serving module 806, advertisement interface 808, flowchart 200, and/or flowchart 700 may include or be implemented as computer program code configured to be executed in one or more processors. Alternatively, content capture module 104, location determiner 106, content annotating module 108, content uploader 110, content capture module 300, camera 302, content capture module 400, video camera 402, texting module 404, email tool 406, location determiner 500, GPS module 502, annotated content serving system 610, annotated content serving system 800, content request interface 804, content serving module 806, advertisement interface 808, flowchart 200, and/or flowchart 700 may include or be implemented as hardware logic/electrical circuitry.

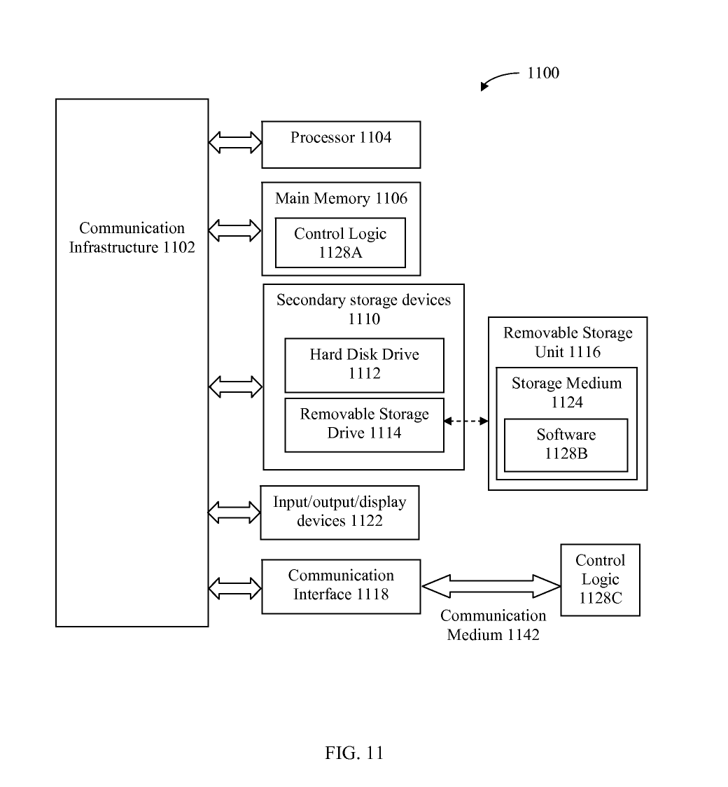

The embodiments described herein, including systems, methods/processes, and/or apparatuses, may be implemented using well known servers/computers, such as a computer 1100 shown in FIG. 11. For example, handheld portable device 102, user devices 604a-604c, content server 606, advertisement server 608, computing device 1002, and any of the sub-systems or components contained therein may be implemented using one or more computers 1100.

When a server, computer 1100 may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Such a server may include one or more operating systems, such as Windows Server, Mac OS X, Unix, Linux, FreeBSD, or the like.

When a user device or client device, computer 1100 may include or may execute a variety of operating systems, including a personal computer operating system, such as a Windows, iOS or Linux, or a mobile operating system, such as iOS, Android, or Windows Mobile, or the like. Such a user device or client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. Such a user device or client device may also include or execute an application to communicate content, such as, for example, textual content, multimedia content, or the like. Such a user device or client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

Computer 1100 can be any commercially available and well known computer capable of performing the functions described herein, such as computers available from International Business Machines, Apple, Sun, HP, Dell, Cray, etc. Computer 1100 may be any type of computer, including a desktop computer, a server, etc.

Computer 1100 includes one or more processors (also called central processing units, or CPUs), such as a processor 1104. Processor 1104 is connected to a communication infrastructure 1102, such as a communication bus. In some embodiments, processor 1104 can simultaneously operate multiple computing threads.

Computer 1100 also includes a primary or main memory 1106, such as random access memory (RAM). Main memory 1106 has stored therein control logic 1128A (computer software), and data.

Computer 1100 also includes one or more secondary storage devices 1110. Secondary storage devices 1110 include, for example, a hard disk drive 1112 and/or a removable storage device or drive 1114, as well as other types of storage devices, such as memory cards and memory sticks. For instance, computer 1100 may include an industry standard interface, such a universal serial bus (USB) interface for interfacing with devices such as a memory stick. Removable storage drive 1114 represents a floppy disk drive, a magnetic tape drive, a compact disk drive, an optical storage device, tape backup, etc.

Removable storage drive 1114 interacts with a removable storage unit 1116. Removable storage unit 1116 includes a computer useable or readable storage medium 1124 having stored therein computer software 1128B (control logic) and/or data. Removable storage unit 1116 represents a floppy disk, magnetic tape, compact disk, DVD, optical storage disk, or any other computer data storage device. Removable storage drive 1114 reads from and/or writes to removable storage unit 1116 in a well-known manner.

Computer 1100 also includes input/output/display devices 1122, such as monitors, keyboards, pointing devices, etc.

Computer 1100 further includes a communication or network interface 1118. Communication interface 1118 enables computer 1100 to communicate with remote devices. For example, communication interface 1118 allows computer 1100 to communicate over communication networks or mediums 1142 (representing a form of a computer useable or readable medium), such as LANs, WANs, the Internet, etc. Network interface 1118 may interface with remote sites or networks via wired or wireless connections.

Control logic 1128C may be transmitted to and from computer 1100 via the communication medium 1142.

Any apparatus or manufacture comprising a computer useable or readable medium having control logic (software) stored therein is referred to herein as a computer program product or program storage device. This includes, but is not limited to, computer 1100, main memory 1106, secondary storage devices 1110, and removable storage unit 1116. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic, such as computer program code or instructions, for implementing the features of content capture module 104, location determiner 106, content annotating module 108, content uploader 110, content capture module 300, camera 302, content capture module 400, video camera 402, texting module 404, email tool 406, location determiner 500, GPS module 502, annotated content serving system 610, annotated content serving system 800, content request interface 804, content serving module 806, advertisement interface 808, flowchart 200, and/or flowchart 700 (including any step of flowcharts 200 and 700), and/or further embodiments described herein. Embodiments of the invention are directed to computer program products comprising such logic (e.g., in the form of program code or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

The invention can work with software, hardware, and/or operating system implementations other than those described herein. Any software, hardware, and operating system implementations suitable for performing the functions described herein can be used.

### IV. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
receiving a request to display content, the content having previously been captured by a handheld portable device that includes a location determiner, the handheld portable device having automatically annotated the content with metadata indicating a location determined by the location determiner of where the content was captured;
requesting an advertisement based at least on the indicated location; and
providing the content to be displayed with the requested advertisement.

2. The method of claim 1, wherein the content includes an image and the handheld portable device includes a camera used to capture the image; and
said providing comprising
providing the image to be displayed with the requested advertisement.

3. The method of claim 2, wherein the content includes at least one of a video, a text message, or an email message.

4. The method of claim 2, wherein the indicated location is indicated in the metadata as an exchangeable image file format (EXIF) tag.

5. The method of claim 1, wherein the indicated location is indicated in the metadata at least by latitude and longitude.

6. The method of claim 2, wherein said receiving comprises:
receiving a request to display the image in a web page; and
wherein said providing comprises:
providing the image to be displayed in the web page with the requested advertisement.

7. The method of claim 6, wherein the web page is a page of a photo sharing website; and
said providing comprising
providing the image to be displayed with the requested advertisement in the page of the photo sharing website.

8. The method of claim 7, wherein the image was uploaded to the photo sharing website by a first user; and
wherein said receiving a request to display the image in a web page comprises:
receiving the request to display the image from a second user.

9. The method of claim 8, wherein the indicated location is a first location; and
wherein said receiving the request to display the image from the second user at a second location that is different from the first location.

10. A system, comprising:
a content request interface that receives a request to display content captured by a handheld portable device that includes a location determiner, the handheld portable device having automatically annotated the content with metadata indicating a location determined by the location determiner of where the content was captured;
an advertisement interface that requests an advertisement based at least on the indicated location; and
a content serving module that provides the content to be displayed with the requested advertisement.

11. The system of claim 10, wherein the content includes an image and the handheld portable device includes a camera used to capture the image; and
the content serving module provides the image to be displayed with the requested advertisement.

12. The system of claim 11, wherein the content includes at least one of a video, a text message, or an email message.

13. The system of claim 11, wherein the indicated location is indicated in the metadata as an exchangeable image file format (EXIF) tag.

14. The system of claim 10, wherein the indicated location is indicated in the metadata at least by latitude and longitude.

15. The system of claim 11, wherein the content request interface receives a request to display the image in a web page; and
wherein the content serving module provides the image to be displayed in the web page with the requested advertisement.

16. The system of claim 15, wherein the web page is a page of a photo sharing website; and
the content serving module provides the image to be displayed with the requested advertisement in the page of the photo sharing website.

17. The system of claim 16, wherein the image was uploaded to the photo sharing website by a first user; and
the content request interface receives the request to display the image from a second user.

18. The system of claim 17, wherein the indicated location is a first location; and
the content serving module receives the request to display the image from the second user at a second location that is different from the first location.

19. A computer readable storage medium having computer program instructions embodied in said computer readable storage medium, the computer program instructions comprising:
first computer program instructions that enable a processor to receive a request to display an image captured by a camera of a handheld portable device that includes a location determiner, the handheld portable device having automatically annotated the image with metadata indicating a location determined by the location determiner of where the image was captured, the image uploaded to a website by a computing device associated with a first user and the request received from a computing device associated with a second user;
second computer program instructions that enable a processor to request an advertisement based at least on the indicated location; and
third computer program instructions that enable a processor to provide the image to be displayed in a web page of the website with the requested advertisement at the computing device.

20. The computer readable storage medium of claim 19, wherein the web page is a page of a photo sharing website; and
said third computer program instructions comprising
fourth third computer program instructions that enable a processor to provide the image to be displayed with the requested advertisement in the page of the photo sharing website.
